(19) United States
(12) Patent Application Publication
(10) Pub. No.: US 2007/0255675 A1
(43) Pub. Date: Nov. 1, 2007

(54) Auto-updating, web-accessible database to facilitate networking and resource management

(76) Inventors: Jacquelyn Fuzell-Casey, (US); Timothy Daniel Casey, (US)

Correspondence Address: Timothy D. Casey, 7570 Briwgate Court, Reno, NV, 89523, US

(21) Appl. No.: 11/412,314

(22) Filed: Apr. 26, 2006

(51) Int. Cl. G06F 17/30

(52) U.S. Cl. 707/1

(57) ABSTRACT

A database of information that facilitates networking and resource management. The database includes initial profiles corresponding to entities within a community, company or school, extracted from data sources. The initial profiles are then enhanced by each entity to include their own data. Enhanced profiles are periodically updated from the data sources, and new initial profiles created. Enhanced profiles are required to be verified or updated periodically. Access can be restricted based on the ability to read/write or on the level of data. Operators of the database can decide whether to validate any data or only when enhanced profiles are flagged for validation. A database may be limited to entities within a certain geographic region, company or portion of an organization. Databases can be linked to expand regions, companies or portions covered.

### BRIEF DESCRIPTION OF THE INVENTION

The present invention is related to database systems for storing, organizing and retrieving information, and more particularly to an auto-updating, web-accessible database of information that facilitates business-to-business and individual-to-business networking and resource management for economic development within a community and for other purposes.

### BACKGROUND OF THE INVENTION

A wide variety of entities require more effective and comprehensive tools for identifying and tracking the attributes and capabilities of individuals and/or other entities within their sphere of influence. Without these tools, the ability to facilitate beneficial connections and communication between individuals and/or other entities is hampered. For example, a corporation may desire to assemble of team of employees to pursue a new business opportunity, but be uncertain as to which employees are best suited to perform the necessary tasks to be successful.

Traditionally, supervisors, managers and executives would attempt to assemble teams of appropriate employees based on each leader's knowledge of the employees working within their division, group, team, etc. Many leaders, however do not really understand all of the skills that exist among the employees they manage or supervise. Thus, leaders recommend employees for assignments based on that leader's prior experience with that employee, even though that employee might not be the best match for the assignment, and even though another employee within the same group might be better suited for the assignment. Attempts to address this problem have focused on collecting information from employees about their backgrounds and storing this information within a database that could be searched by their company to find employees that match selected search terms, but such attempts have significant shortcomings.

Likewise local, regional, and national government agencies, as well as private and public-private organizations responsible for promoting and developing economic growth within their city, town, county, region, state or country, have a similar need to build and maintain databases of information about local businesses and individuals, so as to manage this resource information to facilitate opportunities between connected parties, to promote business growth and relocation, and to provide a greater range of services to their constituents and clients. Many successful economic regions are successful because business leaders and entrepreneurs in the region have established strong formal and informal networks for sharing information. It can take many, many years, however, to develop such networks. Other regions around the world today need these same types of networks, but need to build them in less time than they might naturally develop. These regions urgently need a tool that facilitates the rapid development of such networks.

Although databases of information about employees, local businesses, or individuals within a company or geographic area have existed for a long time, they all have certain basic limitations. Databases built from data collected from publicly available sources, such as tax records, business license records, and similar sources, tend to be very content limited. These databases may include the name of the business, its physical address, certain industry identification codes, a contact name, etc. They usually do not, however, include more useful details about the company, such as specifics regarding the nature of their company, the company's capabilities, its capacity, its supplier needs, etc., all of which might be important attributes to anyone looking to match up with that company to do business.

Once a database (whether including employee, individual and business data) is assembled, the information contained within it begins to age, so unless it is constantly updated, the value of the database begins to deteriorate. Further, the individuals and businesses that the database is intended to track are constantly in flux. The environment within a community or company is dynamic; companies are constantly moving into and out of the community, changing the services and/or products they offer, changing capacities, etc. Likewise, company employees come and go, improve their education, gain new experience through exposure to other opportunities, or simple desire for opportunities that no one knows they have the skills to accomplish. So again, unless the database is constantly updated to reflect these changes, it will lack important information over time,

One way in which databases are maintained in a current state is to repopulate the database with the same sources of information used to create it in the first place. If human labor is used to accomplish this task, it can be incredibly expensive and therefore prompt the database builder to only update the database when absolutely necessary, if ever. If human labor is not used, and instead computers are used to update existing fields of data or to populate new fields of data, there is a great potential for data loss or duplication.

Data loss could occur when detailed data in a field is replaced with less detailed data. While computer software used to repopulate the data fields might be able to make determinations about the quantity of data in a field to be updated, i.e., “there is less data in the old field than the new one, so replace the old date,” that software will not be able to make qualitative comparisons between the existing data and the new data. Likewise, if the software in instructed to favor maintaining data over replacing it, the data in different fields might be duplicated many times over after a series of updates.

Some databases allow businesses or individuals to create their own presence within the database by entering their own data, which can then be updated by whoever created the data in order to keep it current. The problem with this as a solution in many cases is that data entered by such businesses or individuals lacks authenticity. Thus, a company may make claims regarding its size, the quality of its products or services, or capabilities of the company that do not turn out to be true, which ultimately hurts the dishonest company, but which also seriously damages the integrity of the database and other users' willingness to rely upon it in the future.

A further problem with private databases, such as those described above, is their accessibility. This may not be an issue within larger companies that have the ability to establish intranets, but establishing a reliable and secure externally accessible network can be a big challenge for many smaller organizations. If a database can only be accessed in a limited number of locations, its usefulness is greatly diminished. For example, many economic development organizations have databases of information about local businesses, but if someone outside of that organization wants to search for information within that database, they either have to go to the organization's office or send a request to the organization to have the search run for them. The lack of interactivity that results under such conditions can compromise the desirability of the search and the usefulness of the outcome.

Although powerful Internet search engines effectively create humongous databases out of all of the accessible websites in the world, and are frequently used to attempt to find information about businesses in local communities, they are inadequate in many ways. For example, search engines are only able to find information that is already on the Internet. Thus, if a business or individual does not have a website, they cannot be found by a search engine. Search engines, such as Google™, also tend to return inaccurate and irrelevant data, even when attempts have been made to limit the search engine results to businesses in a single geographic region. And such geographically limited results are just as likely to exclude relevant businesses because they do not include the key words that were used to create the search limitations. Finally, the websites upon which search engines rely are entirely dependent on the content of the websites searched, such that if the information contained therein is old and dated, or untrue, then the search results will likewise be old and dated and/or untrue.

### BRIEF DESCRIPTION OF THE SEVERAL VIEWS OF THE DRAWING

FIG. 1 is a block diagram illustrating the preferred embodiment of the present invention; and

FIG. 2 is a flow chart illustrating the development, enhancement, publication and validation of a profile.

### DETAILED DESCRIPTION OF THE INVENTION

The present invention is related to database systems for storing, organizing and retrieving information, and more particularly to an auto-updating, web-accessible database of information that facilitates localized business-to-business and individual-to-business networking and resource management to support economic development and for other purposes. In the preferred embodiment of the invention, the database is used to collect, store, organize and make available information about many different entities, such as businesses and individuals within a particular geographic region, but it has equal applicability to many other situations, such as managing the resource skill sets of employees within a corporation or other institutions and organizations, including universities, governmental agencies and the like.

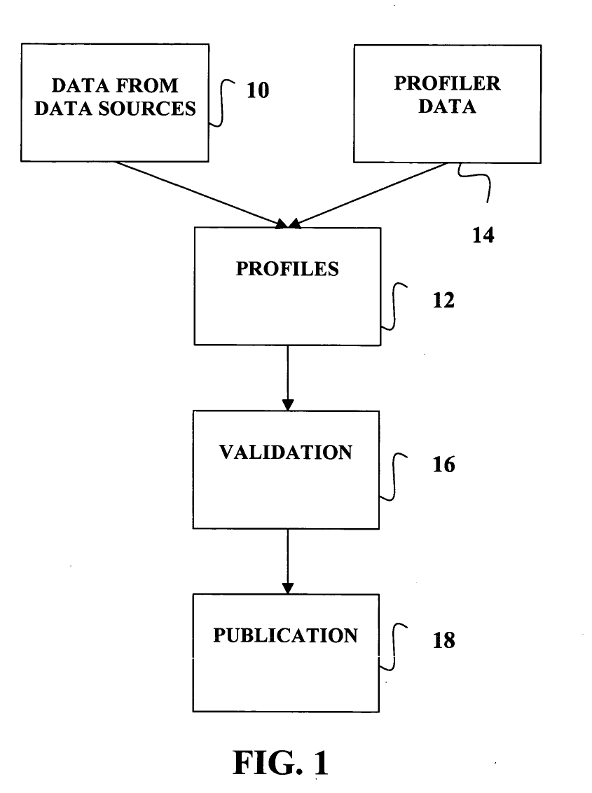

In the preferred embodiment, data is collected from the organization to be served, such as an economic development authority or a corporation (business), from a potentially large number of different sources. As illustrated in FIG. 1, data could be input from a number of data sources 10. If the organization to be served is a corporation, then data could be extracted from various public and private sources, such as internal corporate databases, employee resumes, employee written documents, etc. If the organization to be served is a governmental or public/private entity, relevant data may be stored in different public and private sources, such as town, city, county, state or regional data sources, including business license records, permitting records, tax records, membership lists, text documents, etc.

The data sources used by companies, governmental and public/private entities to store and organize some of their information vary widely as well. Some of the more popular proprietary and open source databases include: MySQL, Oracle, Microsoft SQL Server, Sybase, Sybase SQL Anywhere, Informix, PostgreSQL, FrontBase, SQLite, Interbase, Foxpro, Access, ADO, DB2, SAP DB and ODBC. Some of these databases make it relatively easy to export data stored in the database in a variety of formats. In other cases, it might be necessary to use one or more data extraction software tools to extract data from these databases in particular formats so that data can then be used in other databases. An open source data extraction tool called ADOdb supports all of the databases listed above.

In other cases, there may be no readily available product designed to extract data from certain old, proprietary data sources and translate that data into some usable format. In such cases, it might be necessary to write drivers for existing extraction tools or create new extraction tools just to use the data in some other form. Since the methods that will be used to extract data from old data sources will vary depending on the data source, it is not possible or realistic to attempt to explain those methods in this description. Moreover, it is not necessary to describe such methods herein because anyone of skill in the art of the present invention will be able to create the needed methods.

As previously noted, data can also be entered from a variety of text documents, such as employee resumes, research papers, and other sources. As the format of such documents will vary greatly, a variety of tools will be needed to reliably extract the most necessary and useful information from these sources. As in the case of extracting data from old data sources, the methods to be used to extract this data need not be explained herein for an enabling disclosure of the present invention because the present invention is concerned with how the input source data is put to use, not how the data is input from data sources.

In the preferred embodiment of the present invention, as illustrated in FIG. 1, data input from the data sources 10 is then formatted into a profile 12. The profile 12 can be constructed to look many different ways, depending on the entity being serviced by the database, the type of data input from the data sources, and the type of data input by the profiled entity. The profile for a business might include the business' name, its physical addresses, its website, various contact names, the type of businesses in which the business is engaged, industry classification codes, the number of people employed, the products and services of the business, financial data, part or component suppliers it might need, the type of customers it targets, its manufacturing capacity, and much more. Initially, the fields for a profile might be established based on the type of data input from the data sources only. Over time, however, these fields might be modified to accommodate unique aspects of the data within a certain community. For example, within certain communities, the serviced entity might be very interested in promoting community involvement and might include a field related to that subject, whereas other communities might be interested in other data.

Reliance on the data from the data sources 10 alone to adequately populate each of the fields in a profile 12 will rarely be sufficient. Also, since some of the data used to originally populate a profile 12 will change over time, the data in the profiles 12 will need to be updated. Reloading data from the data sources 10 on a regular basis is one solution employed by the present invention, but that solution is not sufficient for a truly up to date database, especially since using such data comes with the inherent danger of data loss when good data is replaced with bad data or inadequate data. The present invention resolves this issue by also regularly seeking a second source of detailed data for profiles 12 from the profiled parties (the “profilers”) themselves. Such profiler data 14, as set forth in FIG. 1, would include corrections to the data from the data sources 10, as well as additions, modifications, enhancements, etc., to that data, resulting in an enhanced profile.

For example, once a profile 12 had been created using data from the data sources 10, that profile 12 would then be sent to the profiler for verification and/or correction. The profiler would review the profile, correct data in existing fields, fill in data in empty fields, or even create additional fields that were not included in the profile 12 so as to essentially create a very detailed, enhanced profile 12.

Profiles 12 could be sent to profilers in a variety of different fashions. If an email address was available, such as for a contact person, from the data sources 10, then that email address could be used. Alternatively, a physical address could be used, or even both could be used just to make sure the profile was delivered to the profiler. Some profiles may not include email addresses for the appropriate person at the profiler to fill in the profile, so physically mailing the profile to the profiler with instructions on how to access it online might be necessary. Once the profiler accesses the profile and enhances it, the profiler can also provide additional details to the operator of the database on who to contact for future updates, to deal with validation issues, etc.

Every database might require the utilization of different techniques in order to get profilers to participate in enhancing the data in the profiles 12. Profilers in some communities or companies might just need to be asked to encourage them to enhance their profiles, whereas profilers in other communities or companies might need to be coerced into participating. The particular methods used in different communities could vary significantly. The key is to use any methods reasonable necessary to establish a database of enhanced profiles.

Also, once an enhanced profile has been created, it should be validated 16, as illustrated in FIG. 1. The validation process will vary from community to community and from company to company depending on many circumstances. Some profilers may enter inaccurate data that will need to be corrected or deleted before the enhanced profile can be made available to the users of the database. Other profilers might need further encouragement to include data that has been omitted during the profile enhancement process.

One validation method requires a central administrator to review each of the enhanced profiles, to research the accuracy of the data included in the enhanced profile (as far as the central administrator is able to do so), and to correct any incorrect data before the enhanced profile is published 18, i.e., made available to others through the database. Another validation method publishes the enhanced profile first, but then flags the profile in the event any question is raised regarding the content of the profile. Once a profile is flagged, it can either be removed from publication, or simply denoted as being subject to question, until any issue with the profile is resolved.

For example, if Company B was reviewing a profile for Company A and noted that Company A claimed to have ten years of experience providing a particular service that Company B thought Company A had only recently begun to offer, then Company B could notify the publisher of the database of the possible discrepancy. The publisher of the database would then flag the Company A profile and contact Company A for validation of the questioned data. If Company A could not provide support for its claim, it might be required to edit its profile, but if Company A could support the claim, the flag would be removed. The manner in which this type of validation process would transpire would obviously vary from publisher to publisher. The preferred embodiment of the present invention would utilize some combination of the two validation methods, such as where a minimal check is performed prior to publication, with additional validation occurring should an issue be raised after publication.

In the preferred embodiment of the present invention, when a database is published, it is published on the Internet and anyone wanting to access the database would do so by entering an appropriate URL into an Internet browser and going to the database's access page. The access page would for the initial user interface to the database and would require users to enter a user name and password to access additional user interface screens permitting access to the database itself, but these aspects of the invention could be structured in many different ways. For example, the user interface could be very basic so it was easy to use by even the least sophisticated computer user, or it could be quite complex, thereby allowing more sophisticated users more features and functions.

Access restrictions could be structured to so as to make one level of information from the database publicly available to anyone on the Internet, while a second or higher level of information would only be accessible to registered users, and a third level might only be available to the operator of the database, the administrator. In the later case, development authorities might want to collect detailed information about business in their region, such as sales revenues, profits, average wages, employees, hiring trends, customers, suppliers, etc., but the businesses providing this information will not want it to be available outside of the development authorities. In such cases, an administrative level of access might be required for the more sensitive information.

Similarly, profilers would access their initial profiles, over the Internet, in the same manner so as to create enhanced profiles. Once the enhanced profiles were published, the profilers would be able to access the enhance profiles over the Internet in order to make additional changes to their enhanced profiles and to perform other administrative duties. It is well known in the art how to control access to database servers, websites, and even different levels of information within a website.

A further feature of the present invention involves the manner in which access is provided to the database. If a regional economic development authority was the publisher of the database, they might wish to use the database as a revenue generator for the authority. They could do this by charging access fees each time someone accessed the database, or by simply charging a fee to each of its members. Since there are often many more businesses and potential profilers in a community than there are members of the local development authority, access to the information in the database could be used as a recruitment tool for new members or as an added benefit for existing members.

A further important feature of the present invention is the inherent localized nature of the data it contains. For example, when used by a local economic development organization, the present invention could be limited to only include information about companies and individuals within that organization's service territory. This would allow anyone performing a search of data in the database to be able to rely on the local nature of the search results, without having to utilize other potentially incorrect geographic limiting factors, such as a company address or contact address. Many companies have multiple offices all over the country, making it virtually impossible to gather accurate information about that company's presence and capabilities within a certain geographic area.

Furthermore, when a geographic indicator is used, it is often either over inclusive or under inclusive. For example, for a search of companies in northern Nevada, a search query would not want to just use “Nevada” as the geographic limiter because the search results would include businesses in the southern part of the state, as much as a ten hour drive from the north. Likewise, using “Reno,” the largest city in northern Nevada, in the search request would exclude search results in Sparks, Carson City, Fernley, Fallon, Garnerville, and many other local cities and towns in northern Nevada. Since the database of the present invention can be structured to only contain data about local companies or individuals, there is no need to attempt to use geographic limiters in the search query.

A further feature of the present invention is the ability to link databases without intermixing the data contained by each one. This allows different databases utilized by different entities to be kept separate and distinct while increasing the geographic area or corporate focus to be covered for a search. For example, Division A and Division B within a company might utilize their own versions of the database limited to just the employees within their respective divisions, but by linking the Division A database with the Division B database, the breadth of coverage can be increased. Likewise, when used by local economic development authorities, the databases used by different local authorities within a larger region could be combined to represent the capabilities and capacity of the region as a whole. Naturally, this could be done on a state, multi-state, national or international level as well.

A variety of known techniques can be utilized to interconnect these databases for purposes of implementing this feature of the present invention. For example, a traditional database cluster could be used, which distributes data over a group of interconnected databases residing on multiple servers, or nodes. Alternatively, an open-source solution, such as MySQL AB, could be used, which uses a distributed, in-memory clustering architecture that causes the databases in the cluster to work as a single, fault-tolerant database running on low-cost commodity hardware and software. Clustering technologies enable mainframe-level reliability with response times of 5 to 10 milliseconds and throughput rates of 100,000 replicated transactions per second, so users will not be able to tell the difference in response times whether using a single local database or an international network of clustered databases.

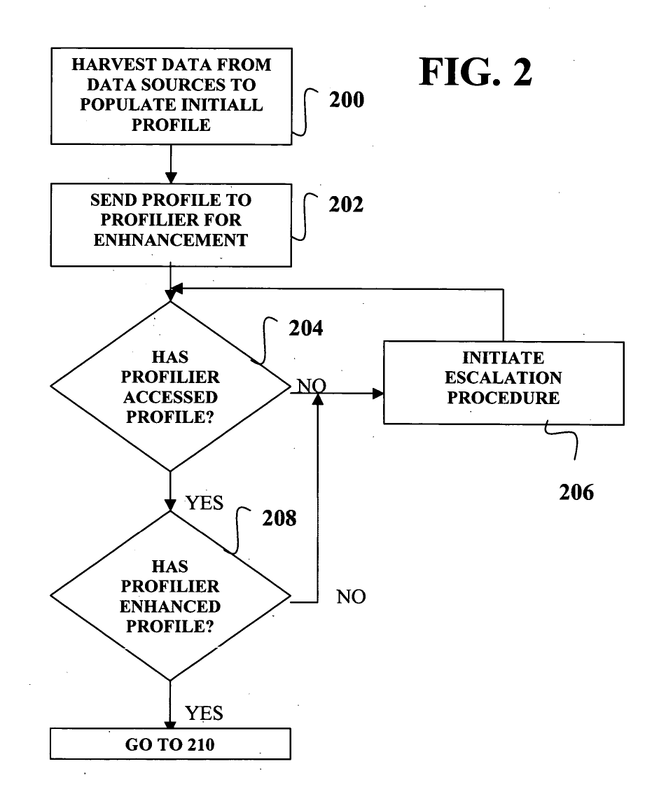

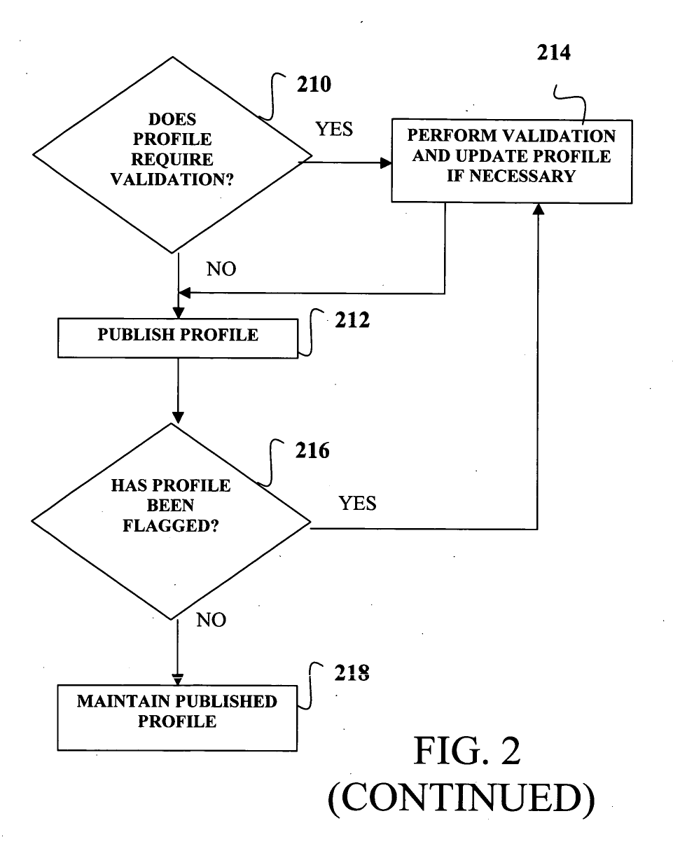

With reference now to FIG. 2, the process for developing, enhancing, publishing and validating a profile within the database will be discussed in greater detail. In step 200, data is harvested from a variety of data sources to populate a central database comprised of a series of initial profiles about different businesses and individuals. As previously noted, the content of the initial profiles will depend entirely on the initially harvested data, which might be extensive, but which might also be quite scant. In step 202, the initial profiles created in step 200 are sent to the profilers for verification (if the initial profile includes all of the necessary details about the profiler), addition/correction (if some of the information in the profile is missing or needs to be corrected), or enhancement (if the profiler wants to add additional details and information that was not necessarily part of the initial profile. To simplify matters from hereon, the verification, addition/correction or enhancement of an initial profile will be referred to as an “enhancement.”

As some profilers may not enhance their profiles expeditiously, step 204 checks to see whether the profiler has accessed the profile at all. If not, step 206 initiates an escalation procedure that will be designed to encourage or compel the participation of each of the profilers. This procedure can be a one-size fits all approach, specific to the particular profiler involved, or different procedures can be developed for different groups of profilers. Again, the particular escalation approach utilized is not as important to the present invention as the general need for some form of escalated cooperation. If the profiler has accessed the profile, as queried in step 204, then step 208 checks to see whether the profiler has enhanced the profile. If not, then the process routes back to step 206 and the escalation procedure. If the profile has been enhanced, then in step 210, a determination is made as to whether the profile needs to validated.

Since enhancement can include verification that everything is fine with a profile, verified profiles do not need to be separately validated. In such cases, the process proceeds to step 212, with the publication of the profile. If the profile has been corrected, added to or otherwise enhanced, then validation might be required. In step 214, profiles that require validation are validated and updated as necessary. As previously noted, the validation process can vary from database to database. Some development authorities may not be overly particular about the accuracy of the information contained in a profile, so they may not perform any validation, or only a cursory form of validation, such as calling the profiler to make sure of the changes that were made. Other development authorities might be very particular about the accuracy of the profiles, in which case extensive validation might be required, such as independently checking each profile. If something is found in a profile that is not correct, or which makes the development authority uncomfortable, then the profile can be updated during the validation process to change or remove the questionable data. Once the profile has been updated, the process can be reiterated by sending the profile back to the profiler, or the profile can be published in step 212.

A profile is published when it is made available to someone other than the profiler and the validator. When profiles are only made available to the development authority, then a profile would be considered published when it was first made available to the development authority after being verified/updated. When profiles are made available to a larger audience, then they would be published when that occurred. Publication of a profile can also include less than all of the information in a profile. For example, some profiles may include details about a business' revenue, number of employees, suppliers, customers, etc., that would be of relevance to the development authority, but which might be considered to be too sensitive to be made available to competitors or other parties. Hence, each profile will need to include different publication levels for different fields within the profile. One publication level could include all of the information in the profile, whereas a second publication level could include only a subset of that information and so on.

Also, once a profile has been published, there needs to be a way in which the profile can be flagged should a concern be raised about the content of that profile. In step 216, the process periodically checks to see if a validation flag has been raised. If so, the process routes back to step 214 to perform the validation process. If not, then the profile continues to be published as before in step 218. As previously noted, the manner in which a validation flag is handled, or even if they exist as a capability at all, depends on the needs of the development authority. Some development authorities may not want users of the database to raising flags about other users due to concerns of abuse or simply because the development authority does not want to be bothered with having to re-verify the data in question. Other development authorities might forgo the initial validation process in favor of a user validation process that allows users to liberally flag profiles in question as a means of maintaining the integrity of the database. Likewise, different development authorities might treat flagged profiles differently, with some leaving them published, but noting when a profile has been flagged, and with others immediately removing a flagged profile until any issues with the profile have been resolved. As the flagging process is periodic, then the result of step 218 would naturally route back to step 216 until the next flag check is performed.

The present invention, while illustrated and described in terms of a preferred embodiment and several alternatives, is not limited to the particular description contained in this specification. Additional alternative or equivalent components and steps could be used to practice the present invention.

1. A database for facilitating networking between a plurality of entities and managing data associated with said plurality of entities, comprising:
a plurality of initial profiles, many of said initial profiles being a single different initial profile corresponding to a single different entity among said plurality of entities, each of said single different initial profiles including data about said single different entity collected from one or more data sources other than directly from said single different entity;
a plurality of enhanced profiles, many of said enhanced profiles being a single different enhanced profile based on a single different initial profile corresponding to a single different entity, many of said single different enhanced profiles including data about a single different entity collected directly from said single different entity; and
a remotely accessible user interface that permits one or more access restrictions to said initial profiles and to said enhanced profiles, each single different initial profile only being accessible by a corresponding single different entity and an operator of said database, each single different enhanced profile only being accessible for modification by a corresponding single different entity and said operator but being accessible by said plurality of entities and said operator to facilitate networking among said plurality of entities.

2. The database of claim 1, wherein said data from said data sources is periodically collected and utilized to create new initial profiles to add to said plurality of initial profiles and to update many of said enhanced profiles.

3. The database of claim 1, wherein said user interface is operable to periodically block access to one of said single different enhanced profiles unless said single different enhanced profile is periodically accessed by said corresponding single different entity to either verify or update said data about said single different entity.

4. The database of claim 3, wherein said data from said data sources is periodically collected and utilized to create new initial profiles to add to said plurality of initial profiles and to update many of said enhanced profiles.

5. The database of claim 1, wherein said user interface is operable to block access to one of said single different enhanced profiles until said data about a single different entity has been validated by said operator.

6. The database of claim 5, wherein said user interface is operable to block access to one of said single different enhanced profiles in the event a flag is raised regarding said data about a single different entity.

7. The database of claim 6, wherein said user interface blocks access to a flagged profile until said data about a single different entity has been validated said operator

8. The database of claim 5, wherein said user interface only blocks access to one of said single different enhanced profiles after a flag has been raised regarding said data about a single different entity.

9. The database of claim 1, wherein said remote access is provided over the Internet through a commonly available Internet browser.

10. The database of claim 1, wherein said access restrictions include one or more limitations on access to different types of data contained in each single different enhanced profile accessible by said plurality of entities and said operator to facilitate networking among said plurality of entities

11. The database of claim 1, wherein said plurality of entities is restricted to entities within a certain geographic area, within a certain organization, or within a certain part of an organization.

12. The database of claim 11, further comprising a linkage for interconnecting said database with another database containing a set of different enhanced profiles about a different plurality of entities within a different geographic area, within a different certain organization, or within a different certain part of said organization and for sharing said plurality of enhance profiles and said set of different enhanced profiles between said plurality of entities and said different plurality of entities.

13. The database of claim 1, wherein data in said enhanced profiles includes address data, website data, contact data, business type data, employment data, product/service data, financial data, customer data, manufacturing data, and supplier data.

14. A method for developing and operating a database for facilitating networking between a plurality of entities and managing data associated with said plurality of entities, comprising the steps of:
creating a plurality of initial profiles, many of said initial profiles being a single different initial profile corresponding to a single different entity among said plurality of entities, said step of creating a plurality of initial profiles including the step of extracting data about said single different entity from one or more data sources other than directly from said single different entity and collecting said data about said single different entity in said single different initial profile;
creating a plurality of enhanced profiles, many of said enhanced profiles being a single different enhanced profile based on a single different initial profile corresponding to a single different entity, said step of creating a plurality of enhanced profiles including collecting data about a single different entity directly from said single different entity and incorporating said data about a single different entity into said single different enhanced profile; and
restricting access through a remotely accessible user interface so that each single different initial profile can only be accessed by a corresponding single different entity and an operator of said database and so that each single different enhanced profile can only be accessed for modification by a corresponding single different entity and said operator while being accessible by said plurality of entities and said operator to facilitate networking among said plurality of entities.

15. The method of claim 14, further comprising the step of periodically collecting said data from said data sources to create new initial profiles to add to said plurality of initial profiles and to update many of said enhanced profiles.

16. The method of claim 14, wherein said step of restricting access includes the step of blocking access to one of said single different enhanced profiles unless said single different enhanced profile is periodically accessed by said corresponding single different entity to either verify or update said data about said single different entity.

17. The method of claim 14, wherein said step of restricting access includes the step of blocking access to one of said single different enhanced profiles until said data about a single different entity has been validated by said operator.

18. The method of claim 14, wherein said step of restricting access includes the step of blocking access to one of said single different enhanced profiles in the event a flag is raised regarding said data about a single different entity.

19. The method of claim 14, wherein said step of restricting access includes the step of limiting access to different types of data contained in each single different enhanced profile accessible by said plurality of entities and said operator to facilitate networking among said plurality of entities

20. The method of claim 14, wherein said plurality of entities is restricted to entities within a certain geographic area, within a certain organization, or within a certain part of an organization, said method further comprising the step of interconnecting said database with another database containing a set of different enhanced profiles about a different plurality of entities within a different geographic area, within a different certain organization, or within a different certain part of said organization and for sharing said plurality of enhance profiles and said set of different enhanced profiles between said plurality of entities and said different plurality of entities.
